(19) United States
(12) Patent Application Publication
(10) Pub. No.: US 2017/0096919 A1
(43) Pub. Date: Apr. 6, 2017

(54) DAMPER ASSEMBLY FOR A COMBUSTION CHAMBER

(71) Applicant: ANSALDO ENERGIA SWITZERLAND AG, Baden (CH)

(72) Inventors: Jost IMFELD, Scherz (CH); Roger ERNST, Rufenach (CH); Laurent Fabien LAVILLE, Niedergosgen (CH)

(73) Assignee: ANSALDO ENERGIA SWITZERLAND AG, Baden (CH)

(21) Appl. No.: 15/285,887

(22) Filed: Oct. 5, 2016

(30) Foreign Application Priority Data
Oct. 5, 2015 (EP) 15188366.7

(51) Int. Cl. F01N 1/02; G10K 11/16; F23R 3/42

(52) U.S. Cl. CPC F01N 1/02; F23R 3/42; G10K 11/161; F01N 2490/12

(57) ABSTRACT

The present disclosure relates to gas turbines and to a damper assembly for a combustion chamber of a gas turbine. A damper assembly as disclosed herein may be adjusted to different frequencies during operation and/or deactivated for different operation regimes.

### FIELD OF THE INVENTION

The present invention generally relates to gas turbines and more in particular it relates to a damper assembly for a combustion chamber of a gas turbine.

### BACKGROUND

As well known, in conventional gas turbines, acoustic oscillation usually occurs in the combustion chambers of the gas turbines. With the term chamber is intended any gas volume where combustion dynamics occur. In such chambers the flow of a gas (for example a mixture of fuel and air or exhaust gas) with high velocity usually creates noise. Burning air and fuel in the combustion chamber causes further noise. This acoustic oscillation may evolve into highly pronounced resonance. Such oscillation, which is also known as combustion chamber pulsations, can reach amplitudes and associated pressure fluctuations that subject the combustion chamber itself to severe mechanical loads that may decisively reduce the life of the combustion chamber and, in the worst case, may even lead to its destruction.

To reduce the acoustic oscillations noise it is well known in the art to install acoustic damping devices like Helmholtz resonators.

Typically, these kinds of dampers are physical devices that are often positioned around the combustion chamber (on the liner, on the front panel). They usually include an empty cavity (where air can flow) and a neck that connects the volume of the cavity to the combustion chamber.

The resonance frequency and damping power of a Helmholtz damper assembly depends on its geometry and on the flow through its neck.

Once the Helmholtz damper is selected and its geometry fixed, it provides a specific characteristic to damp certain frequencies with a certain growth rate reduction coefficient. According to the teachings of the prior art, the geometry cannot be changed during rig or engine operation.

To change the frequency, or to deactivate a damper assembly, the rig/engine has to be shut off and partly disassembled. However, it will be appreciated that such procedure is time-consuming and during following test run only one configuration can be tested.

Moreover, in the event that a wrong arrangement is chosen, the following test is useless or even an outage has to be repeated. To reduce the risk of such outages and/or unsuccessful tests, normally several damper assemblies are connected to the combustion chamber. Such methodology might eventually lead to engines having a large number of dampers.

In sum, up to now different damping frequencies are achieved with several damper assemblies. Such damper assemblies are always active whether they are needed or not for a specific operation regime (e.g. gas or oil operation or part or full load). If certain damper assemblies would not be needed during full load, purge air would still cool down the combustor chamber and increase NOx.

### SUMMARY OF THE INVENTION

It is an object of the present invention to solve the aforementioned technical problem by providing a damper assembly as substantially defined according to independent claim 1.

According to an aspect of the invention, it is provided a damper assembly for a combustion chamber of a gas turbine, comprising a hollow body provided with a neck and defining at least an internal damper cavity in fluid communication with the combustion chamber through the neck, and wherein the hollow body comprises a movable element adapted to vary a volume of the internal damper cavity.

According to a preferred aspect of the invention, the hollow body comprises stop elements configured to limit a stroke of the movable element.

According to a preferred aspect of the invention, the movable element is adapted to be arranged in a first position correspondent to a maximum volume and in a second position correspondent to a minimum volume of the damper cavity.

According to a preferred aspect of the invention, the hollow body is partitioned into two separate and fluidly communicating first and second damper cavities, wherein the first damper cavity has a fixed volume and the movable member is arranged into the second damper cavity.

According to a preferred aspect of the invention, the movable element may be bucket-shaped.

According to an alternative embodiment, the movable element may be an inner cavity having a fixed volume, in fluid communication with the damper cavity of the hollow body.

According to a preferred aspect of the invention, the damper assembly comprises a plug adapted to be arranged in a first active position correspondent to a maximum volume of the damper cavity in which the combustion chamber is in fluid communication with the damper cavity, and in a second closed position where the plug is inserted into the neck such to deactivate the damper assembly.

According to a preferred aspect of the invention, the plug is mounted on the movable element.

According to a preferred aspect of the invention, the damper assembly comprises a drive arrangement associated to the movable element.

According to a preferred aspect of the invention, the drive arrangement comprises a compressed air feeding system and a sealing element associated to the movable element.

According to a preferred aspect of the invention, the compressed air feeding system (15 is arranged such to feed compressed air in a pressurised volume delimited by a wall of the movable element and an internal wall of the hollow body.

According to a preferred aspect of the invention, the sealing element is adapted to seal the damper cavity from the pressurised volume.

According to a preferred aspect of the invention, the sealing element is a compensator arranged around the movable element and disposed along an internal wall of the hollow body.

According to a preferred aspect of the invention, the sealing element is made of a resilient material.

Advantageously, the damper assembly according to the present invention may be adjusted to different frequencies online and/or deactivated, as it will become apparent with the detailed description of some exemplary and non-limiting embodiments.

Moreover, with such procedure it may also be more exactly evaluated how many damper assemblies are actually needed for stable combustor operations.

It will also be appreciated that the adjustable damper according to the invention allows saving time for testing or may be adjusted to a preferred damping frequency during engine operation for different operation regimes.

### BRIEF DESCRIPTION OF DRAWINGS

The foregoing objects and many of the attendant advantages of this invention will become more readily appreciated as the same becomes better understood by reference to the following detailed description when taken in conjunction with the accompanying drawings, wherein:

FIG. 1 shows a lateral section of a single cavity damper assembly (top) and a double cavity damper assembly (bottom) according to the prior art;

FIG. 2 shows a lateral section of a damper assembly according to a first preferred embodiment of the present invention;

FIG. 3 shows a lateral section of a damper assembly according to a second preferred embodiment of the present invention;

FIG. 4 shows a lateral section of a damper assembly according to a third preferred embodiment of the present invention;

FIG. 5 shows a lateral section of a damper assembly according to a forth preferred embodiment of the present invention;

FIG. 6 shows a lateral section of a damper assembly according to a fifth preferred embodiment of the present invention.

FIGS. 7 and 8 show a different usage of the damper assembly according to the invention when associated to a combustion chamber.

Preferred embodiments of the present invention will be now described in detail with reference to the aforementioned drawings.

### DETAILED DESCRIPTION OF THE INVENTION

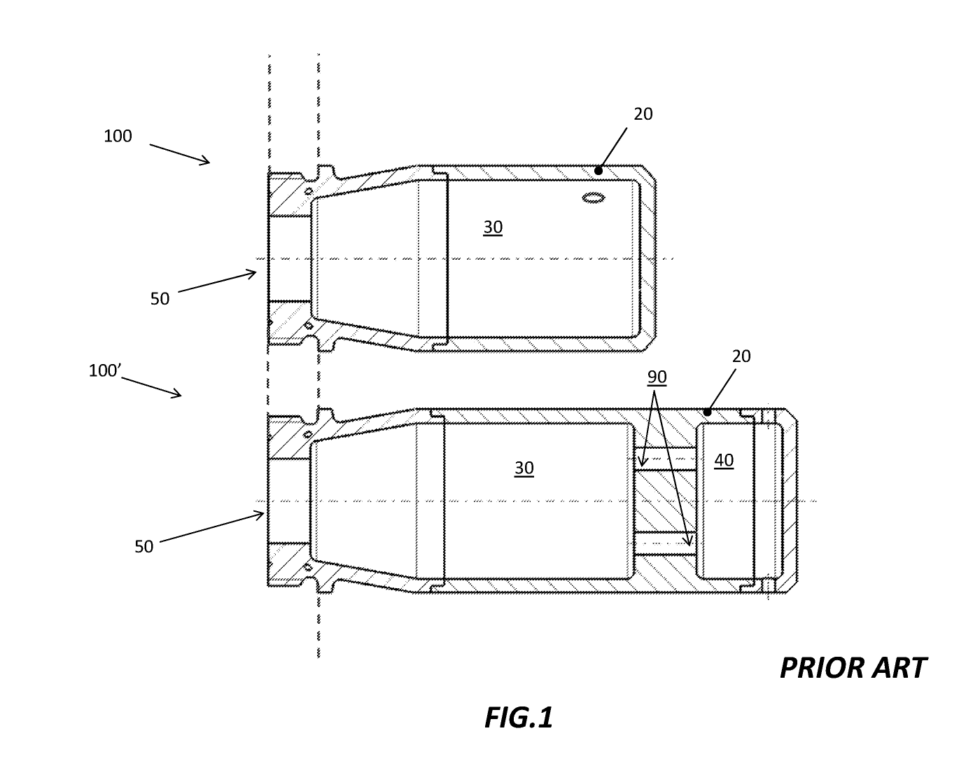

With reference to FIG. 1, it is showed a side view of damper assemblies 100 and 100′ according to the prior art. In particular, damper assembly 100 comprises a hollow body 20 which defines a single cavity 30, the single cavity having a fixed volume. Damper assembly 100 is in fluid communication with a combustion chamber (not shown) through a neck 50. The damping frequency of damper assembly 100 depends on its geometry, and thus is fixed and cannot be changed during testing or normal operation.

Damper assembly 100′ differs from damper 100 in the fact that is a double volume cavity. More specifically, damper assembly 100′ includes a hollow body 20 which internally defines two damper cavities 30 and 40, which are in fluid communication through internal ducts 90. Similarly, damper assembly 100′ has fixed inner volumes of the cavities, and hence the damping frequency is fixed as well.

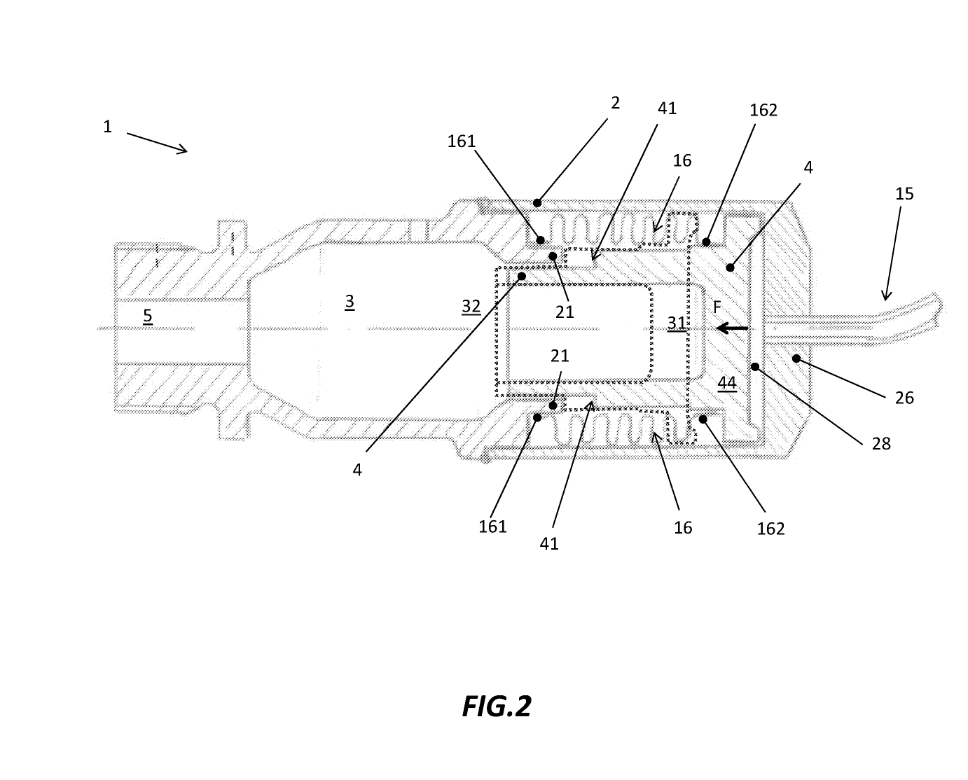

Making now reference to the following FIG. 2, it is shown a lateral section of a damper assembly 1 according to a first exemplary and non-limiting embodiment of the present invention.

Damper assembly 1 comprises a hollow body 2 which defines an internal damper cavity 3. The internal cavity 3 is in fluid communication with a combustion chamber (not shown) through a neck 5, located on the hollow body 2. According to an aspect of the invention, hollow body 2 comprises a movable element which is adapted to vary a volume of the damper cavity 3.

In the first and non-limiting preferred embodiment, the movable element is bucket-shaped and it is indicated with numeral reference 4. The cross-section shown in the figure of the movable element 4 is C-shaped.

The movable element 4 is adapted to be arranged in a first position, which corresponds to a maximum volume 31 of the damper cavity 3, and in a second position (indicated dashed in the figure) corresponding to a minimum volume 32 of the damper cavity 3.

To this end, to the movable element 4 is associated a drive arrangement, which includes a compressed air feeding system, generally indicated with numeral reference 15, and a sealing element 16 which is associated to the movable element 4.

Still with reference to FIG. 2, it is shown the movable element 4 in the first position which corresponds to a maximum volume 31 of the damper cavity 3, which is associated to a first damping frequency. In particular, maximum volume 31 is defined by external walls of the hollow body 2 and the internal walls of the bucket-shaped member 4, located in the hollow body 2.

When it is wished to switch to a second damping frequency, different from the first damping frequency, the air feeding system 15 provides compressed air which is fed into a pressurised gap 28, formed between a wall 44 of the movable member 4 and the back wall 26 of the hollow body 2.

Advantageously, the pressurized gap 26 is sealed by the sealing element 16 from the damper cavity 3. The compressed air fed into the gap 28 pushes the movable member 4 along direction of arrow F until stop elements 21 limit a stroke of the movable element 4. To this end, element 4 includes along its side walls steps 41, which are configured to abut against stop elements 21. When the movable element 4 reaches the second operative condition (dashed in the figure) the steps 41 abut against stop elements 21. The minimum volume 32 of the damper cavity 3, which corresponds to the new position of the movable element 4, substantially equals the maximum volume 31 decreased of the volume of the gap 28 filled with compressed air. The new decreased volume 32, accomplished with the movable member 4 in its second operative position, enables the damper assembly 1 to provide a damping frequency which differs from the damping frequency obtained with the movable member configured in its first operative position.

Hence, advantageously, damper assembly 1 provides the combustion chamber with two different damping frequencies, which are remotely obtainable by driving the compressed air feeding system 15 which in turn acts on the position of the movable member within the damper cavity 3.

According to a preferred and non-limiting embodiment, sealing element 16 is a compensator, which is arranged around the bucket-shaped movable element 4 and disposed along an internal wall of the hollow body 2, as shown in the lateral cross section of FIG. 2.

In particular, compensator 16 is tightly connected, preferably by welding, at a first edge 161 to the hollow body 2 and, at a second edge 162, to the movable member 4.

Generally, the sealing element 16 separates the pressurised gap 28 from the pressure established in or around the combustor chamber, that is the pressure in the damper cavity 3. With the sealing function, the leakage is substantially avoided and the mass flow through the pressure feed pipe 15 is only present during activation/deactivation, but not during stable operation.

Advantageously, with such arrangement the pressure feed pipe 15 can be designed with a small size, that is having tubes with a diameter equal or less than 5 mm.

On the contrary, if conventional seals (e.g. piston rings) were used, the leakage would have to be compensated with a certain flow through the pressure line and therefore would require a bigger pipe.

Preferably, the compensator 16 is made of a resilient material, to further offer a spring-like reaction versus the movable element 4 during its stroke.

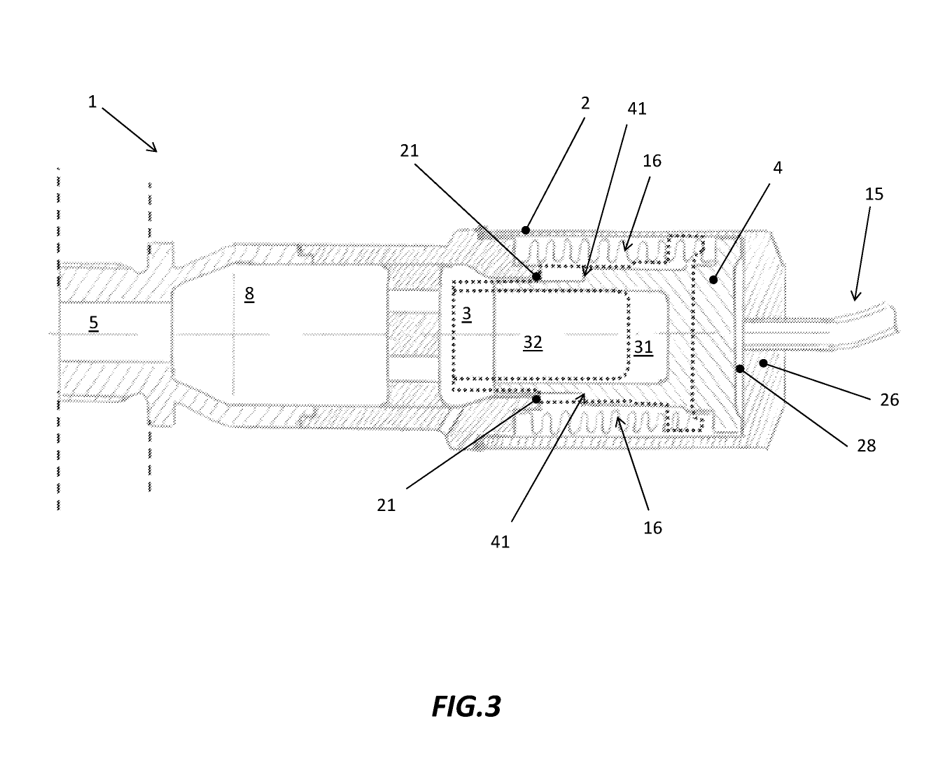

Making now reference to the following FIG. 3, it is shown the damper assembly 1 according to a second exemplary embodiment. This embodiment is equivalent to the first embodiment with the difference that damper assembly 1 is a double cavity assembly. In particular, damper assembly 1 is partitioned into two separate and fluidly communicating damper cavities: a first damper cavity 8 which has a fixed volume, and a second damper cavity 3. The movable member 4 is located inside damper cavity 3 which then has a variable volume. The mode of operation of movable member 4 inside damping cavity 3 in this second exemplary embodiment is equal to the first embodiment above described.

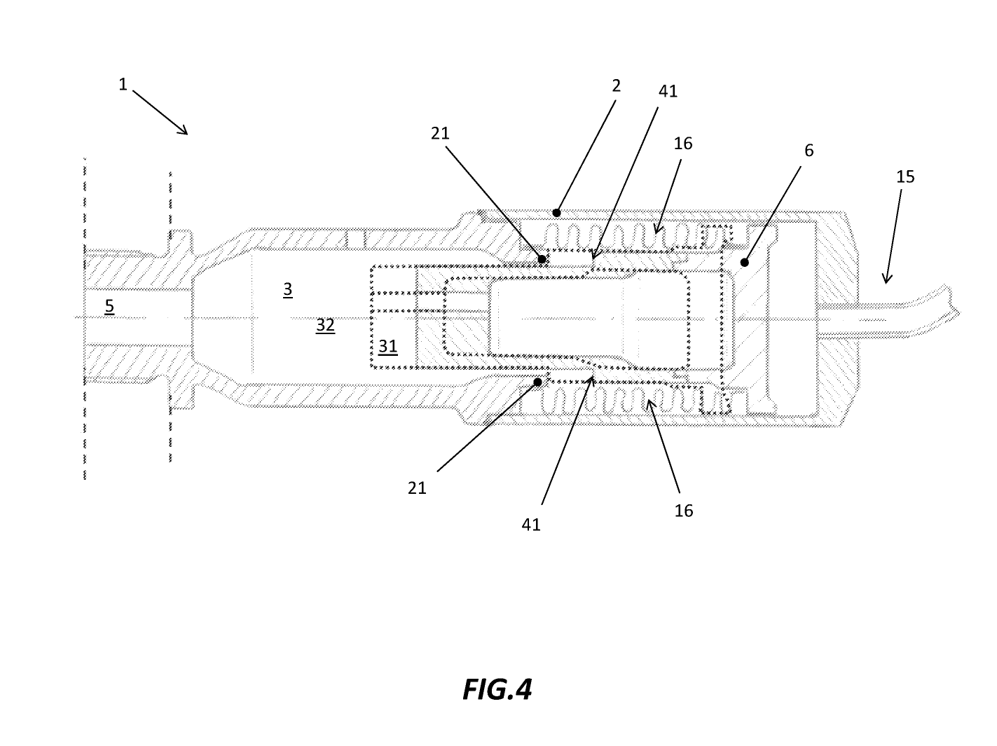

With reference to FIG. 4, it is shown a third preferred embodiment of the present invention.

In this embodiment, the movable element is an inner cavity 6 in fluid communication with damper cavity 3. The movement of the cavity 6 from a first position corresponding to the maximum volume 31 to the second position corresponding to the minimum volume 32 is operated in an analogous way as described for first and second exemplary embodiments.

The inner cavity 6 has a fixed volume, while damper cavity 3 has a variable volume due to the movement of the inner cavity 6 from its first operative position to the second operative position (dashed).

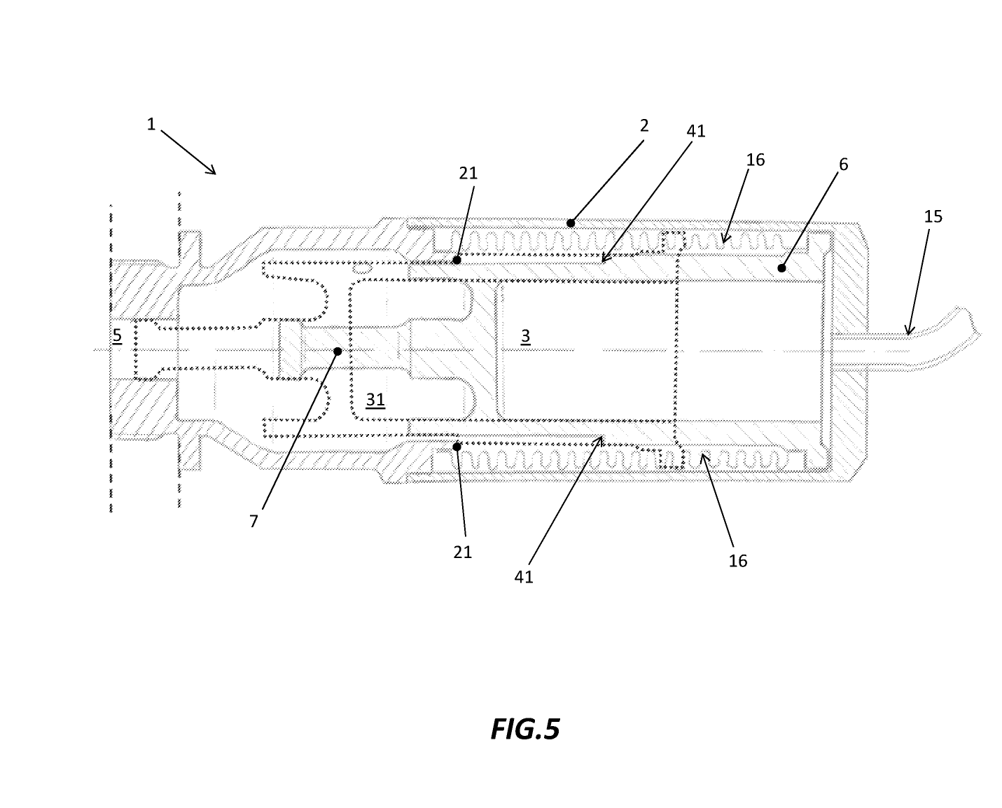

With now reference to the following FIG. 5, it is shown the damper assembly according to a forth preferred embodiment.

In this forth embodiment, damper assembly 1 comprises a plug 7 which is adapted to be arranged in a first active position in which the damper cavity 3 is in fluid communication with the combustion chamber (not shown) through the neck 5, and in a second closed position wherein the plug 7 is inserted into the neck 5 and obstructs it (position dashed in the figure), such to deactivate the damper assembly 1.

In the preferred and non-limiting example herewith detailed, the plug 7 is mounted on the movable element 6, which in this case is an inner cavity located inside the damper cavity 3. With such arrangement, the damper assembly 1 is a de-activatable damper assembly. However, the movable element may also be bucket-shaped like the first embodiment shown and/or positioned into an associated damper cavity as shown for the second embodiment, or in any other shapes.

In fact, when movable member 6 is in its first operative position, damper cavity 3 is characterised by maximum volume 31 and plug 7 does not engage into the neck 5.

Hence, combustion chamber is in fluid communication with damper assembly which operates with a damping frequency which depends on volume 31. When movable member is shifted to its second operative position, the plug 7 is inserted into the neck 5 and obstructs the passage (position dashed in the figure). In this way the damper assembly 1 is deactivated, or, in other words, the minimum volume corresponding to the second operative position of the movable member 6 is equal to zero.

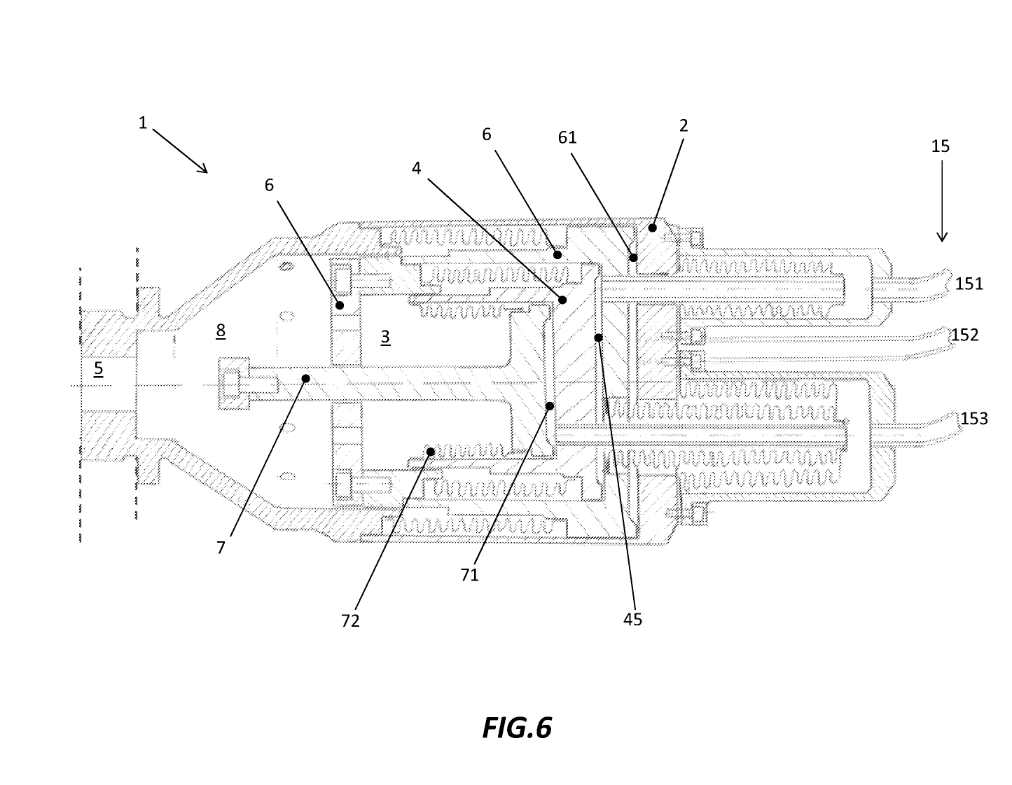

With reference to FIG. 6, it is shown the damper assembly 1 according to a fifth embodiment of the present invention.

In this embodiment, compressed air feeding system 15 includes separated and independent feeding systems 151, 152 and 153.

In particular, feeding system 153 acts solely on the plug element 7, moving it from an active position when the plug 7 is not inserted into the neck 5, and thus the damper is active, to a deactivated position wherein the plug 7 is inserted into the neck 5. The movement of the plug 7 occurs by means of pressurized air filling a gap 71 which then moves the plug 7 against sealing element 72.

Feeding system 151 acts, in a similar way, on movable member 4, filling gap 45, and varies the volume inside the damping cavity 3.

Lastly, feeding system 152 acts on movable member 6, filling with pressurised air gap 61, and varies the volume of damping cavity 8, operating in an analogous way as described above.

So, advantageously, this embodiment provides a double cavity damper assembly which has both cavities, in fluid communication between each other, having adjustable volumes by means of feeding air system 151 and 152, and also provides the possibility for the damper assembly 1 to be deactivated by means of feeding air system 153 acting on the plug 7.

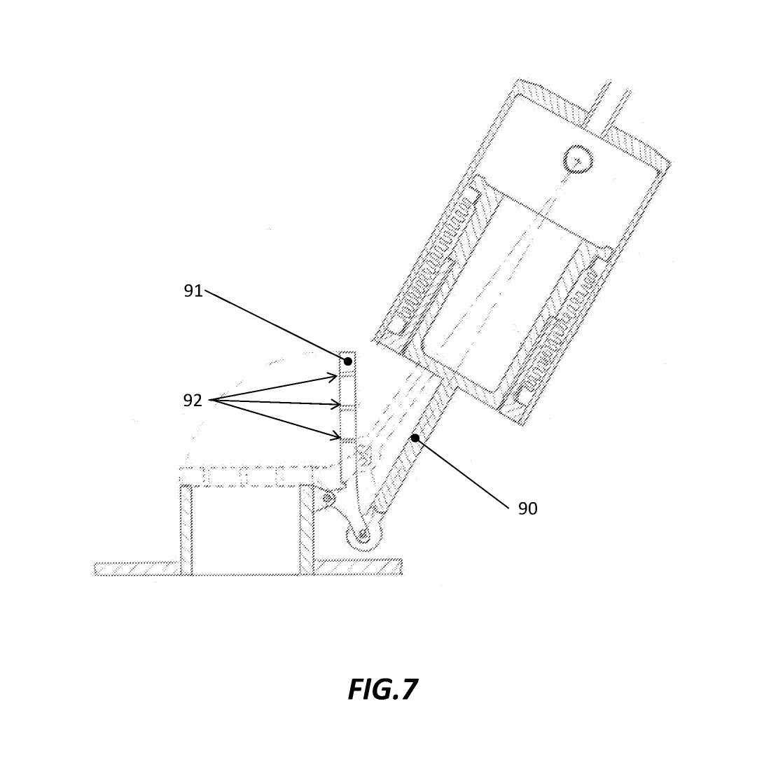

With reference not to FIG. 7, it is shown an alternative usage of the movable element as explained above, to close also very large damper volumes (e.g. Low-Frequency Helmholtz Damper) with the same pneumatic movable piston concept.

In this case the movable element, operating as described above, terminates with a piston 90 which is hinged to a flap 91, which is in turn hinged to a neck 92 of the damper volume. Advantageously, the flap 91 is provided with purge holes 93.

This is advantageous if the damper neck is very large and/or the needed movable range of the movable part exceeds the design limits. In this case, the piston will not directly insert a plug into a neck, but activate a flap to close the neck. With this technique, the damper volume cannot be adjusted, but the damper can be activated/deactivated during rig/engine operation.

Preferably the flap can be rotated around an axis perpendicular to the neck axis or also parallel to it.

Clearly also every other angle can be imagined.

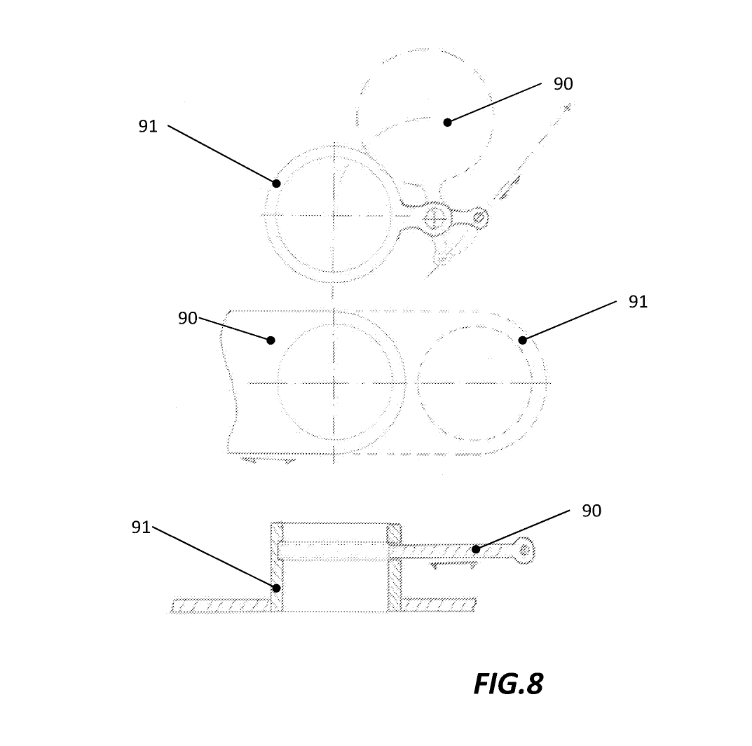

FIG. 8 shows that different way of closures associated to the piston 90 and the neck 91 are possible.

For example, piston 90 may act as a slide can be designed with many different shapes. A simple plate with higher movement range, or with holes or half-moon shaped openings that enclose the neck in open position.

Although the present invention has been fully described in connection with preferred embodiments, it is evident that modifications may be introduced within the scope thereof, not considering the application to be limited by these embodiments, but by the content of the following claims.

1. A damper assembly for a combustion chamber of a gas turbine, the damper assembly comprising:
a hollow body provided with a neck, said hollow body defining at least an internal damper cavity for fluid communication when in operation with a combustion chamber through said neck said hollow body having a movable element to vary a volume of said internal damper cavity.

2. The damper assembly according to claim 1, wherein said hollow body comprises:
stop elements configured to limit a stroke of said movable element.

3. The damper assembly according to claim 1, wherein said movable element has a first position correspondent to a maximum volume and a second position corresponding to a minimum volume of said damper cavity.

4. The damper assembly according to claim 3, wherein said hollow body is partitioned into two separate and fluidly communicating first and second damper cavities, wherein the first damper cavity has a fixed volume and said movable member is arranged into the second damper cavity.

5. The damper assembly according to claim 1, wherein said movable element is bucket-shaped.

6. The damper assembly according to claim 1, wherein said movable element is an inner cavity in fluid communication with said damper cavity of said hollow body, said inner cavity having a fixed volume.

7. The damper assembly according to claim 1, comprising:
a plug having a first active position in which a combustion chamber will be in fluid communication with the damper cavity, and a second closed position where said plug is inserted into said neck to deactivate said damper assembly.

8. The damper assembly according to claim 7, wherein said plug is mounted on said movable element.

9. The damper assembly according to claim 1, comprising:
a drive arrangement associated with said movable element.

10. The damper assembly according to claim 9, wherein said drive arrangement comprises:
a compressed air feeding system and a sealing element associated with said movable element.

11. The damper assembly according to claim 10, wherein said compressed air feeding system is configured and arranged to feed compressed air in a pressurised gap delimited by a wall of said movable element and a back wall of said hollow body.

12. The damper assembly according to claim 11, wherein said sealing element is configured to seal said damper cavity from said pressurised gap.

13. The damper assembly according to claim 12, wherein said sealing element is a compensator arranged around said movable element and disposed along an internal wall of said hollow body.

14. The damper assembly according to claim 10, wherein said sealing element is made of a resilient material.
